(19) United States
(12) Patent Application Publication
(10) Pub. No.: US 2013/0135714 A1
(43) Pub. Date: May 30, 2013

(54) NEAR INFRARED CUT FILTER GLASS AND PROCESS FOR PRODUCING THE SAME

(71) Applicant: Asahi Glass Company, Limited, Chiyoda-ku (JP)

(72) Inventors: Yuki KONDO, Chiyoda-ku (JP); Hiroyuki OHKAWA, Chiyoda-ku (JP); Seiki OHARA, Chiyoda-ku (JP)

(73) Assignee: Asahi Glass Company, Limited, Chiyoda-ku (JP)

(21) Appl. No.: 13/747,893

(22) Filed: Jan. 23, 2013

Related U.S. Application Data
(63) Continuation of application No. PCT/JP2011/067702, filed on Aug. 2, 2011.

(30) Foreign Application Priority Data
Aug. 3, 2010 (JP) 2010-174447

(51) Int. Cl. C03C 4/08; G02B 5/20

(52) U.S. Cl. CPC C03C 4/082; G02B 5/20
USPC 359/359; 65/134.1; 65/29.1

(57) ABSTRACT

To provide a near infrared cut filter glass which has few bubble defects and exhibits high climate resistance.

A near infrared cut filter glass made of fluorophosphate glass, which comprises, as represented by cation percentage, 25 to 55% of P⁵⁺, 1 to 25% of Al³⁺, 1 to 50% of R⁺ (wherein R⁺ is a total content of Li⁺, Na⁺ and K⁺), 1 to 50% of R²⁺ (wherein R²⁺ is a total content of Mg²⁺, Ca²⁺, Sr²⁺, Ba²⁺ and Zn²⁺), 1 to 10% of Cu²⁺ and 0 to 3% of Sb³⁺, and comprises as represented by anion percentage, 35 to 95% of O²⁻ and 5 to 65% of F⁻, and which has a β-OH value of from 0.001 to 0.1 mm⁻¹.

### FIELD OF INVENTION

The present invention relates to a near infrared cut filter glass which is used for a color calibration filter of e.g. a digital still camera or a color video camera, which has few bubbles, and which is excellent in climate resistance.

### BACKGROUND OF INVENTION

A solid-state imaging element such as a CCD or a CMOS used for e.g. a digital still camera has a spectral sensitivity over from the visible region to the near infrared region in the vicinity of 1,200 nm. Accordingly, since no good color reproducibility will be obtained as it is, the luminosity factor is corrected by using a near infrared cut filter glass having a specific substance which absorbs infrared rays added. As such a near infrared cut filter glass, an optical glass having CuO added to fluorophosphate glass, in order to selectively absorb wavelengths in the near infrared region and to achieve a high climate resistance, has been developed and used. As such glass, the composition is disclosed in Patent Document 1.

Heretofore, in a case of producing glass containing phosphoric acid, usually, H₃PO₄ (orthophosphoric acid) is widely used as a raw material containing phosphoric acid. Orthophosphoric acid is stable in property in a liquid state as reacted with a certain amount of water, and therefore accurate preparation is possible. Further, as the phosphoric acid raw material containing a certain amount of water, it has been proposed to use a phosphate powder raw material having water of crystallization, such as a tripolyphosphate powder (Patent Document 2). Although the phosphoric acid raw material is a powder raw material, it is possible to supply water thereto at the time of production of glass, and further glass raw materials can easily be prepared.

By the way, along with increase of the number of pixels of solid-state imaging elements in recent years, the pixel density tends to be high, and the pixel size tends to be small. Accordingly, requirements to the quality for a near infrared cut filter glass, such as a size or occurrence frequency of bubble defects, become more severe than ever.

### PRIOR ART DOCUMENTS

### Patent Documents

Patent Document 1: JP-A-3-83834

Patent Document 2: JP-A-2006-213546

### SUMMARY OF INVENTION

### Technical Problem

However, with respect to the fluorophosphate glass employing phosphoric acid as a raw material, if the water content in the glass is high, there are following problems.

(1) Bubbles in the glass increase. This is a phenomenon remarkably observed when a crucible or a melting bath made of a platinum-type material is used in a step of melting glass raw materials. On comparison between hydrogen mobility and oxygen mobility of a platinum-type material, the hydrogen mobility is higher than the oxygen mobility. Accordingly, in the water contained in the glass, hydrogen selectively permeates through platinum and leaves from a glass melt, and therefore the remaining oxygen is formed as oxygen bubbles at the intersurface between a glass melt and platinum.

(2) The climate resistance deteriorates. If fluorophosphate glass having a high water content is melted, hydrogen in the water and fluorine in the glass raw material are bonded to form HF, and HF is volatilized from glass, whereby fluorine remaining in the glass decreases. Fluorine contributes to the improvement of the climate resistance by replacing a P═O bond or a P—OH bond in the glass with a P—F bond and therefore if fluorine remaining in the glass decreases, the climate resistance of the glass deteriorates.

The present invention has been made under the above circumstances, and by focusing on the water content in the glass, it is an object of the present invention to provide a near infrared cut filter glass having few bubble defects and exhibiting high climate resistance.

### Solution to Problem

The present inventors have found it possible to obtain a near infrared cut filter glass having few bubble defects and exhibiting high climate resistance, in a case where the β-OH value showing the water content in a fluorophosphate glass is within a specific range.

That is, the near infrared cut filter glass of the present invention is made of fluorophosphate glass, which comprises, as represented by cation percentage:

P⁵⁺ 25 to 55%,

Al³⁺ 1 to 25%,

R⁺ 1 to 50% (wherein R⁺ is a total content of Li⁺, Na⁺ and K⁺),

R²⁺ 1 to 50% (wherein R²⁺ is a total content of Mg²⁺, Ca²⁺, Sr²⁺, Ba²⁺ and Zn²⁺),

Cu²⁺ 1 to 10% and

Sb³⁺ 0 to 3%,

and comprises as represented by anion percentage:

O²⁻ 35 to 95% and

F⁻ 5 to 65%,

and which has a β-OH value of from 0.001 to 0.1 mm⁻¹.

Further, the near infrared cut filter glass of the present invention has a transmittance at a wavelength of 400 nm of from 75 to 92%, a transmittance at a wavelength of 700 nm of from 5 to 10% and a transmittance at a wavelength of 1,200 nm of from 10 to 20%, when calibrated such that the wavelength at which the transmittance is 50% is 615 nm, and further has a wavelength on a long wavelength side at which the transmittance is 50%, of from 575 to 700 nm, as calculated as a thickness of 0.3 mm, in a spectral transmittance at a wavelength of from 600 to 700 nm.

Further, the near infrared cut filter glass of the present invention has a liquidus temperature of from 700 to 850° C.

Further, the near infrared cut filter glass of the present invention contains substantially no PbO or As₂O₃.

The process for producing a near infrared cut filter glass of the present invention comprises adjusting the water content of glass to have a β-OH value of from 0.001 to 0.1 mm⁻¹ in a period from heating of a glass raw material to solidification of molten glass, in a process for producing fluorophosphate glass to be used as a near infrared cut filter.

Further, in the process for producing a near infrared cut filter glass of the present invention, the adjustment of the water content is carried out by controlling the time from heating of a glass raw material to solidification of molten glass, to be from 2 to 80 hours.

Further, in the process for producing a near infrared cut filter glass of the present invention, the adjustment of the water content is carried out by supplying a dry gas to the atmosphere in a period from heating of a glass raw material to solidification of molten glass so as to control the dew point to be from −100 to 50° C. in the atmosphere.

Further, in the process for producing a near infrared cut filter glass of the present invention, as the glass raw material, a phosphate powder raw material or orthophosphoric acid having water of crystallization is used.

Further, in the process for producing a near infrared cut filter glass of the present invention, the fluorophosphate glass is a fluorophosphate glass having the above composition.

### Advantageous Effects of Invention

According to the present invention, it is possible to obtain a near infrared cut filter glass having few bubble defects and exhibiting high climate resistance, by adjusting the water content in the glass to a specific range.

### DETAILED DESCRIPTION OF INVENTION

The present inventors have focused on the water content in the glass and confirmed the bubble density of a near infrared cut filter glass and the climate resistance of glass with respect to various glasses. As a result, they have found it possible to obtain a fluorophosphate glass having few bubble defects and exhibiting high climate resistance, by adjusting the β-OH value to from 0.001 to 0.1 mm⁻¹.

The water contained in the glass is present in the form of e.g. P—OH, and can be quantitatively analyzed in the form of β-OH by measuring O—H vibration by means of e.g. Fourier transform infrared spectroscopy. A glass having a high water content has a high β-OH value, and on the other hand, a glass having a low water content has a low β-OH value. If the β-OH value of the glass is too low, there are problems that the stability of glass against devitrification deteriorates and that Cu²⁺ ions are reduced. On the other hand, if the β-OH value of the glass is too high, there is a problem that oxygen bubbles derived from water are formed at the time of glass melting or that the climate resistance of glass is deteriorated by reduction of the amount of the remaining fluorine.

With respect to the near infrared cut filter glass of the present invention, the water (β-OH) is an essential component for improving the stability of glass against devitrification or improving visible transmittance by oxidation of Cu²⁺ ions, and if the β-OH value of the glass is less than 0.001 mm⁻¹, such effects cannot adequately be obtained. Further, if the β-OH value of the glass exceeds 0.1 mm⁻¹, oxygen bubbles are formed at the time of melting glass or the climate resistance of glass is deteriorated by reduction of the amount of the remaining fluorine. The β-OH value is preferably from 0.002 to 0.08 mm⁻¹, more preferably from 0.005 to 0.06 mm⁻¹, further more preferably from 0.01 to 0.05 mm⁻¹.

The β-OH value is an index showing the water contained in glass, and is defined as follows.

β-OH=Log(100/T)/t(mm⁻¹)

Here, T is a transmittance (%) of an absorption peak derived from vibration of O—H observed in a range of from 2,500 to 3,500 mm⁻¹, and can be measured by means of e.g. Fourier transform infrared spectroscopy. t is the thickness (mm) of a sample.

Then, the reason why contents (as represented by cation % or anion %) of the respective components constituting the near infrared cut filter glass of the present invention are limited as mentioned above, will be described below.

P⁵⁺ is a main component (glass forming oxide) forming glass and is an essential component to increase the absorption properties in the near infrared region. If its content is less than 25%, no sufficient effects will be obtained, and if it exceeds 55%, the glass viscosity increases, the liquidus temperature of the glass increases, or the climate resistance becomes low, such being undesirable. It is preferably from 30 to 50%, more preferably from 35 to 45%.

Al³⁺ is a main component (glass forming oxide) forming glass and is an essential component to increase the climate resistance. If its content is less than 1%, no sufficient effects will be obtained, and if it exceeds 25%, glass tends to be unstable, or the infrared absorption properties become low, such being undesirable. It is preferably from 3 to 20%, more preferably from 5 to 18%, furthermore preferably from 7 to 16%.

R⁺ (wherein R⁺ is a total content of Li⁺, Na⁺ and K⁺) is an essential component to lower the melting temperature of glass, to lower the liquidus temperature of glass, to soften glass, and to stabilize glass. If its content is less than 1%, no sufficient effects will be obtained, and if it exceeds 50%, glass tends to be unstable, such being undesirable. It is preferably from 5 to 40%, more preferably from 10 to 35%, furthermore preferably from 15 to 30%.

Li⁺ has effects to lower the melting temperature of glass, to lower the liquidus temperature of glass, to soften glass or to stabilize glass. If its content exceeds 40%, glass tends to be unstable, such being undesirable. It is preferably from 1 to 35%, more preferably from 5 to 32%, furthermore preferably from 10 to 29%.

Na⁺ has effects to lower the melting temperature of glass, to lower the liquidus temperature of glass, to soften glass or to stabilize glass. If its content exceeds 40%, glass tends to be unstable, such being undesirable. It is preferably from 1 to 35%, more preferably from 5 to 32%, furthermore preferably from 10 to 29%.

K⁺ has effects to lower the melting temperature of glass, to lower the liquidus temperature of glass, to soften glass or to stabilize glass. If its content exceeds 40%, glass tends to be unstable, such being undesirable. It is preferably from 1 to 35%, more preferably from 5 to 32%, furthermore preferably from 10 to 29%.

R²⁺ (wherein R²⁺ is a total content of Mg²⁺, Ca²⁺, Sr²⁺, Ba²⁺ and Zn²⁺) is an essential component to lower the melting temperature of glass, to lower the liquidus temperature of glass, to soften glass or to stabilize glass. If its content is less than 1%, no sufficient effects will be obtained, and if it exceeds 50%, glass tends to be unstable, such being undesirable. It is preferably from 5 to 40%, more preferably from 10 to 30%, furthermore preferably from 15 to 30%.

Mg²⁺ has effects to lower the melting temperature of glass, to lower the liquidus temperature of glass, to soften glass or to stabilize glass. If its content exceeds 20%, glass tends to be unstable, such being undesirable. It is preferably from 1 to 15%, more preferably from 2 to 10%, furthermore preferably from 3 to 5%. Ca²⁺ has effects to lower the melting temperature of glass, to lower the liquidus temperature of glass, to soften glass or to stabilize glass. If its content exceeds 40%, glass tends to be unstable, such being undesirable. It is preferably from 1 to 30%, more preferably from 2 to 20%, furthermore preferably from 3 to 10%. Sr²⁺ has effects to lower the melting temperature of glass, to lower the liquidus temperature of glass, to soften glass or to stabilize glass. If its content exceeds 40%, glass tends to be unstable, such being undesirable. It is preferably from 1 to 30%, more preferably from 2 to 20%, furthermore preferably from 3 to 10%.

Ba²⁺ has effects to lower the melting temperature of glass, to lower the liquidus temperature of glass, to soften glass or to stabilize glass. If its content exceeds 40%, glass tends to be unstable, such being undesirable. It is preferably from 1 to 30%, more preferably from 2 to 20%, furthermore preferably from 3 to 10%.

Zn²⁺ has effects to lower the melting temperature of glass, to lower the liquidus temperature of glass, to soften glass or to stabilize glass. If its content exceeds 40%, glass tends to be unstable, such being undesirable. It is preferably from 1 to 30%, more preferably from 2 to 20%, furthermore preferably from 3 to 10%.

Cu²⁺ is an essential component for near infrared absorption. If its content is less than 1%, no sufficient effects will be obtained, and if it exceeds 10%, the visible transmittance will be decreased, such being undesirable. It is preferably from 2 to 8%, more preferably from 3 to 7%.

Sb³⁺ is not an essential component but has an effect to increase the visible light transmittance by lowering redox of copper. If its content exceeds 3%, the stability of glass tends to be decreased, such being undesirable. It is preferably from 0 to 2%, more preferably from 0.01 to 1%, furthermore preferably from 0.05 to 0.5%.

O²⁻ is an essential component to stabilize glass. If its content is less than 35%, no sufficient effects will be obtained, and if it exceeds 95%, the glass tends to be unstable, such being undesirable. It is preferably from 55 to 90%, more preferably from 60 to 85%.

F⁻ is an essential component to stabilize glass and to improve the climate resistance. If its content is less than 5%, no sufficient effects will be obtained, and if it exceeds 65%, the visible light transmittance will be decreased, such being undesirable. It is preferably from 5 to 45%, more preferably from 15 to 40%.

The near infrared cut filter glass of the present invention preferably contains substantially no PbO or As₂O₃. PbO is a component to lower the viscosity of glass and to improve the production workability. Further, As₂O₃ is a component which acts as a fining agent or an oxidizing agent. However, as PbO and As₂O₃ are environmental load substances, they are preferably not contained as far as possible. Here, “containing substantially no” means that such components are not intentionally used as materials, and inevitable impurities included from the material components or in the production step are considered to be not substantially contained. Further, “containing substantially no component” means that its content is at most 0.1% by taking into consideration the inevitable impurities.

The near infrared cut filter glass of the present invention may contain a nitrate compound or a sulfate compound having cation to form glass as an oxidizing agent or a fining agent. The oxidizing agent has an effect to improve the transmittance in the vicinity of wavelengths of from 400 to 600 nm. The amount of addition of the nitrate compound or the sulfate compound is preferably from 0.5 to 10 mass % by the outer percentage based on the material mixture. If the addition amount is less than 0.5 mass %, no effect of improving the transmittance will be obtained, and if it exceeds 10 mass %, formation of glass tends to be difficult. It is more preferably from 1 to 8 mass %, further preferably from 3 to 6 mass %.

The nitrate compound may, for example, be Al(NO₃)₃, LiNO₃, NaNO₃, KNO₃, Mg(NO₃)₂, Ca(NO₃)₂, Sr(NO₃)₂, Ba(NO₃)₂, Zn(NO₃)₂ or Cu(NO₃)₂. The sulfate compound may, for example, be Al₂(SO₄)₃.16H₂O, Li₂SO₄, Na₂SO₄, K₂SO₄, MgSO₄, CaSO₄, SrSO₄, BaSO₄, ZnSO₄ or CuSO₄.

The near infrared cut filter glass of the present invention preferably has a transmittance at a wavelength of 400 nm of at least 75%, more preferably at least 82%, further preferably at least 85%, most preferably at least 87%, when calibrated such that the wavelength at which the transmittance is 50% is 615 nm, in a spectral transmittance at a wavelength of from 600 to 700 nm. Considering loss by surface reflection at the interface between glass and the air, the upper limit of the transmittance at a wavelength of 400 nm is preferably 92%. The near infrared cut filter for a solid-state imaging element is required to have a transmittance in the visible region as high as possible, whereby the visible light which enters the solid-state imaging element can efficiently be brought in, and the sensitivity of the solid-state imaging element can be increased.

Further, the near infrared cut filter glass of the present invention preferably has a transmittance at a wavelength of 700 nm of at most 10%, more preferably at most 9%, most preferably at most 8%, as the near infrared absorption properties, when calibrated such that the wavelength at which the transmittance is 50% is 615 nm, in a spectral transmittance at a wavelength of from 600 to 700 nm. Considering Cu²⁺ which can be stably added to glass, the lower limit of the transmittance at a wavelength of 700 nm is preferably 5%. Further, the transmittance at a wavelength of 1,200 nm is preferably at most 20%, more preferably at most 18%, most preferably at most 16%, when calibrated as above. Considering absorption by Cu²⁺ in glass, the lower limit of the transmittance at a wavelength of 1,200 nm is preferably 10%.

Further, the near infrared cut filter glass of the present invention has a wavelength on a long wavelength side at which the transmittance is 50% of preferably at most 700 nm, more preferably at most 650 nm, most preferably at most 625 nm, as calculated as a thickness of 0.3 mm. Considering the amount of Cu²⁺ which can be stably added to glass, the wavelength on a long wavelength side at which the transmittance is 50% is preferably at least 575 nm. Further, the wavelength on a short wavelength side at which the transmittance is 50%, is usually present between 300 nm and 400 nm.

In optical equipment employing the near infrared cut filter glass, usually image processing (digital processing) is carried out, however, influences of infrared rays with which the solid-state imaging element reacts are considered to be hardly removed by software. Accordingly, it is preferred to absorb infrared rays by the near infrared cut filter glass as far as possible, and the near infrared cut filter glass of the present invention preferably has the above-mentioned transmittance characteristics.

Further, in the above, the transmittance characteristics in the visible region of the near infrared cut filter glass of the present invention are transmittance characteristics calibrated such that the wavelength at which the transmittance is 50% is 615 nm. This is because although the transmittance of glass varies depending on the thickness, in the case of homogenous glass, the transmittance at a predetermined thickness can be determined by calculation when the thickness and the transmittance of glass in the light transmission direction are known.

The near infrared cut filter glass of the present invention is also characterized in that glass is stable. Regarding the glass being stable, the stability in the temperature region in the vicinity of the liquidus temperature TL and the stability in the temperature region in the vicinity of the Glass Transition Temperature Tg are mentioned. Specifically, the stability in the temperature region in the vicinity of the liquidus temperature TL means a low liquidus temperature TL and slow progress of devitrification in the vicinity of the liquidus temperature TL, and the stability in the temperature region in the vicinity of the Glass Transition Temperature Tg means a high crystallization peak temperature Tc and a high crystallization onset temperature Tx, and slow progress of devitrification in the vicinity of Tc and Tx. By such, devitrification hardly occurs in the step of melt forming glass, and glass will easily be produced with a high yield.

The liquidus temperature of the near infrared cut filter glass of the present invention is preferably at most 850° C. If the liquidus temperature of glass exceeds 850° C., the melting temperature or the forming temperature tends to be high, and striae by volatilization of fluorine at the time of glass melting will occur, thus lowering the yield. It is preferably at most 825° C., more preferably at most 800° C., most preferably at most 775° C. Further, as the crystallization onset temperature usually tends to be low when the liquidus temperature is too low, the lower limit of the liquidus temperature is preferably at least 700° C., more preferably at least 725° C.

Now, the process for producing a near infrared cut filter glass of the present invention will be described.

The process for producing a near infrared cut filter glass comprises a melting step for melting glass raw materials, a fining step for removing bubbles in glass, a stirring step for homogenizing glass and a forming step for forming a molten glass by letting it flow out.

The production process of the present invention is to obtain a fluorophosphate glass having a β-OH value of from 0.001 to 0.1 mm⁻¹ finally obtainable, by adjusting the water content of glass in a period from heating of a glass raw material to solidification of molten glass. Here, the reasons why the water content in the glass is controlled in a period from heating of a glass raw material to solidification of molten glass are such that it is possible to readily control the water contained in the glass raw material to a proper range while the glass raw material is heated to obtain a molten glass and while the glass is maintained in a molten state, and that it is difficult to control the water in the glass if the glass is in a vitreous state.

Further, as an apparatus for producing the near infrared cut filter glass of the present invention, it is possible to use a single crucible furnace for the melting step for melting a glass raw material, the fining step for removing bubbles in the glass and a stirring step for homogenizing the glass, or a continuous furnace in which various bathes for carrying out the respective steps are connected via transport pipes.

In the production process of the present invention, the adjustment of the water content is preferably carried out by controlling the time (hereinafter, referred to as a melting time) from heating of a glass raw material to solidification of molten glass, to be from 2 to 80 hours, whereby it is possible to readily control the water contained in the glass raw material to be within a proper range. If the melting time is less than 2 hours, it is difficult to adjust the β-OH value of glass to be from 0.001 to 0.1 mm⁻¹. Further, if it exceeds 80 hours, fluorine in the glass tends to be volatilized, and devitrification tends to occur in the glass, or the climate resistance tends to be low. The preferred range of the melting time is from 6 to 65 hours, more preferably from 10 to 55 hours, most preferably from 20 to 50 hours.

Here, the melting time in the present invention means the time from charging of the glass raw material to a melting furnace in the above melting step, to when molten glass is solidified and formed into a vitreous state (supercooled liquid state) in the above forming step, via the above fining step and the above stirring step.

In the production process of the present invention, the above adjustment of the water content may be carried out by supplying a dry gas to the atmosphere (atmosphere in a furnace such as a melting furnace) in a period from heating of the glass raw material to solidification of molten glass so as to control the dew point to be from −100 to 50° C. in the atmosphere, whereby it is possible to control the water in the glass to be within a proper range. If the dew point in the atmosphere is less than −100° C., the control tends to be difficult. Further, if it exceeds 50° C., it is difficult to adjust the β-OH value of the glass to be within a range of from 0.001 to 0.1 mm⁻¹. The range of the dew point in the atmosphere is preferably from −50 to 30° C., more preferably from −25 to 20° C., most preferably from −15 to 0° C.

Further, as the above dry gas to be supplied to the atmosphere, it is possible to use a gas containing a proper component such as oxygen, nitrogen or air, so long as the dew point in the atmosphere can be controlled to be within a proper range.

In the production process of the present invention, it is preferred to use a phosphoric acid raw material containing water in the raw material, as the glass raw material. The phosphoric acid raw material containing water in the raw material may be a phosphoric acid powder raw material or orthophosphoric acid having water of crystallization such as a tripolyphosphate powder.

The reason why the phosphoric acid raw material containing water is used as the glass raw material is as follows. In the initial step where the glass raw material is formed into a molten glass, effects by water such as suppression of devitrification and suppression of reduction of Cu²⁺ ions are utilized by positively introducing the water into glass. Even when such a phosphoric acid raw material containing water is used, the β-OH value of glass finally obtainable is controlled to be within the above-mentioned range by properly adjusting the water while the glass is in a molten state.

Further, if the water content in the glass raw material is in excess, it is preferred that the respective glass raw material components are mixed, then heated to a temperature of from about 200 to 300° C. so as to adjust to a predetermined water content, and then used as a glass raw material.

According to the near infrared cut filter glass and the production process of the present invention, bubble defects especially caused by oxygen bubbles are less likely to occur because of a low β-OH value as the water content in glass, the climate resistance becomes high because it is possible to suppress volatilization of fluorine, the production properties are excellent because of low liquidus temperature, and the near infrared absorption properties are excellent. Accordingly, such a near infrared cut filter glass can suitably be used as a near infrared cut filter glass to be used for color calibration of a solid-state imaging element.

The near infrared cut filter glass of the present invention can be prepared as follows. First, the raw materials are weighed and mixed so that glass to be obtained has a composition within the above range. This raw material mixture is charged into a platinum crucible and melted by heating at a temperature of from 700 to 1,000° C. in an electric furnace. Thereafter, the molten glass is sufficiently stirred and fined, cast into a mold, annealed, and then cut and polished to be formed into a flat plate having a predetermined thickness. Here, the melting time is from 2 to 80 hours.

In the above production process, the highest temperature of glass in a molten state is usually a temperature at a stage where the glass raw material is melted to obtain a molten glass, and such a temperature (hereinafter referred to as a melting temperature) is preferably at most 950° C. If the temperature of glass in a molten state exceeds 950° C., the equilibrium state of oxidation-reduction of Cu ions will be inclined to Cu⁺ side, whereby the transmittance characteristics will be deteriorated, and volatilization of fluorine will be accelerated and glass tends to be unstable. The above melting temperature is more preferably at most 900° C., most preferably at most 850° C. Further, the above melting temperature is preferably at least 700° C., more preferably at least 750° C., since if it too low, devitrification may occur during melting or it will take long until complete melting.

### EXAMPLES

Examples of the present invention and Comparative Examples are shown in Tables 1 and 2. Further, in this specification, Examples 1 to 17 are Examples of the present invention, and Examples 18 to 20 are Comparative Examples of the present invention. Example 19 corresponds to glass in Example 2 as disclosed in JP-A-2004-83290. Example 20 corresponds to glass in Example 1 as disclosed in JPA-2004-137100. Such glasses were obtained in such a manner that materials were weighed and mixed to achieve compositions (cation %, anion %) as identified in the respective Tables, put in a platinum crucible having an internal capacity of about 300 cc, and the glass raw materials were melted at 850° C. for from 2 to 80 hours. Further, glasses in Comparative Examples were melted at 850° C. for 1 hour. Then, the respective molten glasses were fined and stirred, then cast into a rectangular mold of 50 mm in length×50 mm in width and 20 mm in height preheated to from 300 to 500° C., and then annealed at about 1° C./min to obtain samples.

With respect to the melting properties, etc. of glass, the above samples were visually observed when prepared, and the obtained glass samples were confirmed to have no bubbles or striae. Further, as a raw material of each glass, H₃PO₄ or a tripolyphosphate powder was used in the case of P⁵⁺, AlF₃, aluminum tripolyphosphate or A₂O₃ was used in the case of Al³⁺, RF or RNO₃ was used in the case of R⁺ (R=Li,Na,K), RF₂ , RO or RCO₃ was used in the case of R² (R═Mg,Ca,Sr,Ba,Zn), CuO was used in the case of Cu²⁺, and Sb₂O₃ was used in the case of Sb³⁺.

With respect to the above prepared glass samples, the β-OH value, the bubble density, the climate resistance, the liquidus temperature and the transmittance were evaluated by the following methods.

TABLE 1

| Cation %, anion % | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| P⁵⁺ | 43.4 | 42.8 | 32.5 | 35.2 | 27.5 | 47.9 | 44.0 | 25.4 | 38.5 | 38.8 |
| Al³⁺ | 9.9 | 10.2 | 17.7 | 16.9 | 12.2 | 6.0 | 2.2 | 18.2 | 6.7 | 4.9 |
| Li⁺ | 23.8 | 21.5 | 16.3 | 17.6 | 7.6 | 6.0 | 1.1 | 12.1 | 35.6 | |
| Na⁺ | | 3.0 | | 8.8 | 12.6 | 10.0 | 26.4 | 10.1 | | 35.9 |
| K⁺ | | | 11.6 | | | 6.0 | 1.1 | 14.2 | | |
| R⁺ | 23.8 | 24.5 | 27.9 | 26.4 | 20.2 | 22.0 | 28.6 | 36.4 | 35.6 | 35.9 |
| Mg²⁺ | 5.9 | 6.1 | 7.0 | 7.5 | 10.8 | 8.5 | 6.5 | 6.0 | 1.0 | 1.0 |
| Ca²⁺ | 5.9 | 6.1 | 4.5 | 3.8 | 5.4 | 12.0 | 6.5 | 6.0 | 5.7 | 5.8 |
| Sr²⁺ | 4.0 | 4.1 | 4.6 | 5.0 | 7.2 | 1.2 | 4.4 | 4.0 | 3.8 | 3.8 |
| Ba²⁺ | 3.0 | 3.1 | 3.5 | 3.8 | 15.2 | | 3.3 | 3.0 | 2.9 | 2.9 |
| Zn²⁺ | | | | | | | | | 1.9 | 1.9 |
| R²⁺ | 18.8 | 19.4 | 19.6 | 20.1 | 38.6 | 21.7 | 20.7 | 19.0 | 15.3 | 15.4 |
| Cu²⁺ | 4.1 | 3.1 | 2.3 | 1.1 | 1.5 | 2.4 | 4.5 | 1.0 | 3.9 | 4.9 |
| Sb³⁺ | | | | 0.3 | | | | | | 0.1 |
| O²⁻ | 85.0 | 92.0 | 55.0 | 65.0 | 63.0 | 85.0 | 85.0 | 48.0 | 76.0 | 72.0 |
| F⁻ | 15.0 | 8.0 | 45.0 | 35.0 | 37.0 | 15.0 | 15.0 | 52.0 | 24.0 | 28.0 |
| β-OH [mm⁻¹] | 0.04 | 0.01 | 0.005 | 0.007 | 0.003 | 0.08 | 0.06 | 0.003 | 0.005 | 0.007 |
| Bubble density [cm⁻³] | 8 | 5 | 7 | 10 | 6 | 15 | 12 | 7 | 9 | 10 |
| Climate resistance | No stain | No stain | No stain | No stain | No stain | No stain | No stain | No stain | No stain | No stain |
| Liquidus temperature [° C.] | 814 | 805 | 785 | 795 | 765 | 835 | 790 | 810 | 795 | 792 |
| Transmittance at a | 82.3 | 84.6 | 88.2 | 90.5 | 89.5 | 88.5 | 83.5 | 89 | 82.5 | 88.5 |
| wavelength of 400 nm [%] | | | | | | | | | | |
| Transmittance at a | 7.0 | 6.5 | 6.8 | 6.5 | 6.9 | 6.4 | 6.5 | 6.8 | 7.2 | 6.4 |
| wavelength of 700 nm [%] | | | | | | | | | | |
| Transmittance at a | 14.5 | 14 | 16.5 | 15.5 | 18.5 | 12.5 | 13.4 | 19 | 14.2 | 13.7 |
| wavelength of 1,200 nm [%] | | | | | | | | | | |
| 50% wavelength [nm] | 615 | 629 | 644 | 686 | 667 | 643 | 610 | 688 | 617 | 605 |
| Melting time (h) | 4 | 15 | 30 | 21 | 50 | 2 | 3 | 50 | 30 | 21 |

TABLE 2

| Cation %, anion % | Ex. 11 | Ex. 12 | Ex. 13 | Ex. 14 | Ex. 15 | Ex. 16 | Ex. 17 | Ex. 18 | Ex. 19 | Ex. 20 |
|---|---|---|---|---|---|---|---|---|---|---|
| P⁵⁺ | 39.4 | 42.3 | 32.7 | 34.0 | 36.8 | 37.2 | 44.2 | 43.4 | 39.0 | 28.0 |
| Al³⁺ | 4.8 | 6.0 | 4.7 | 4.9 | 5.3 | 5.3 | 12.6 | 9.9 | 15.6 | 13.9 |
| Li⁺ | | 6.0 | 1.9 | 1.9 | 2.1 | 2.1 | 2.5 | 23.8 | 12.0 | 23.3 |
| Na⁺ | | 2.4 | 1.9 | 1.9 | 2.1 | 2.1 | 2.5 | | 6.9 | 7.4 |
| K⁺ | 35.6 | 2.4 | 11.2 | 11.7 | 12.6 | 12.8 | 17.7 | | | |
| R⁺ | 35.6 | 10.8 | 15.0 | 15.5 | 16.8 | 17.0 | 22.7 | 23.8 | 18.9 | 30.7 |
| Mg²⁺ | 1.0 | 1.2 | 0.9 | 1.0 | 1.1 | 1.1 | 2.5 | 5.9 | 3.7 | 3.1 |
| Ca²⁺ | 5.7 | 14.4 | 28.0 | 1.9 | 2.1 | 2.1 | 1.3 | 5.9 | 7.8 | 6.5 |
| Sr²⁺ | 3.8 | 7.2 | 5.6 | 29.1 | | | 3.8 | 4.0 | 5.7 | 4.7 |
| Ba²⁺ | 2.9 | 9.6 | 7.5 | 7.8 | 31.6 | 0.5 | 3.8 | 3.0 | 4.9 | 4.0 |
| Zn²⁺ | 1.9 | 2.5 | 1.9 | 1.9 | 2.1 | 31.9 | | | | 5.3 |
| R²⁺ | 15.3 | 34.9 | 43.9 | 41.7 | 36.9 | 35.6 | 11.4 | 18.8 | 22.1 | 23.6 |
| Cu²⁺ | 4.9 | 6.0 | 3.7 | 3.9 | 4.2 | 4.3 | 8.8 | 4.1 | 4.4 | 3.7 |
| Sb³⁺ | | | | | | 0.6 | 0.3 | | | 0.1 |
| O²⁻ | 70.0 | 73.0 | 69.0 | 67.0 | 68.0 | 75.0 | 74.0 | 85.0 | 68.5 | 59.1 |
| F⁻ | 30.0 | 27.0 | 31.0 | 33.0 | 32.0 | 25.0 | 26.0 | 15.0 | 31.6 | 40.9 |
| β-OH [mm⁻¹] | 0.009 | 0.008 | 0.002 | 0.005 | 0.02 | 0.04 | 0.06 | 0.2 | 0.3 | 0.2 |
| Bubble density [cm⁻³] | 11 | 9 | 4 | 5 | 10 | 12 | 15 | 214 | 344 | 124 |
| Climate resistance | No | No | No | No | No | No | No | Stain | Stain | Stain |
| | stain | stain | stain | stain | stain | stain | stain | observed | observed | observed |
| Liquidus temperature [° C.] | 801 | 818 | 777 | 780 | 765 | 789 | 815 | 801 | 826 | 762 |
| Transmittance at a | 78.0 | 73.1 | 84.5 | 83.9 | 82.8 | 88.9 | 87.3 | 78.0 | 83.1 | 81.0 |
| wavelength of 400 nm [%] | | | | | | | | | | |
| Transmittance at a | 6.7 | 6.6 | 6.9 | 6.8 | 7.0 | 7.2 | 6.8 | 6.7 | 7.2 | 6.6 |
| wavelength of 700 nm [%] | | | | | | | | | | |
| Transmittance at a | 13.0 | 13.5 | 16.5 | 16.3 | 15.5 | 14.3 | 13.8 | 13.0 | 14.2 | 17.3 |
| wavelength of 1,200 nm [%] | | | | | | | | | | |
| 50% wavelength [nm] | 605 | 594 | 619 | 617 | 613 | 612 | 574 | 615 | 618 | 625 |
| Melting time (h) | 17 | 19 | 75 | 30 | 8 | 4 | 3 | 1 | 1 | 1 |

β-OH (mm⁻¹) was evaluated by a Fourier transform infrared spectrophotometer (manufactured by THERMO ELECTRON Co., Ltd., tradename: NICOLET6700). Specifically, a glass sample of 20 mm in length×20 mm in width and 0.3 mm in thickness, both surfaces of which were optically polished, was prepared, and measurement was conducted. Further, it was confirmed that the bubble composition was oxygen by a micro-Raman spectroscope (manufactured by THERMO ELECTRON Co., Ltd., tradename: Nicolet Almega).

With respect to the bubble density, glass was processed into a plate, the number of bubbles in a region of 0.05 cm³ was measured at five positions under a high brightness light source (LA-100T, manufactured by HAYASHI WATCH-WORKS CO., LTD.), and the average of the measured values was multiplied by 20 to obtain a value calculated per unit volume.

The liquidus temperature was measured by a thermal analyzer (manufactured by Seiko Instruments Inc., tradename: Tg/DTA6300). About 1 g of glass was prepared, pulverized by a mortar and a pestle, and using a sample remaining between sieves of 105 μm and 44 μm, measurement was carried out within a measurement range of 200 to 1,000° C. at a temperature-increasing rate of 10° C./min, and based on the obtained DTA curve, the liquidus temperature was determined from the temperature at which the final crystal was melted.

The transmittance was evaluated by an ultraviolet visible near infrared spectrophotometer (manufactured by PerkinElmer, tradename: LAMBDA 950). Specifically, a glass sample of 20 mm in length, 20 mm in width and 0.3 mm in thickness, both surfaces of which were optically polished, was prepared, and measurement was conducted. The transmittance at each wavelength was determined from the spectral transmittance obtained by the above spectrophotometer calibrated such that the wavelength at which the transmittance was 50% was 615 nm.

With respect to the climate resistance, using a high temperature and high humidity bath (manufactured by ESPEC CORP., tradename: SH-221), the optically polished glass sample was maintained in the high temperature and high humidity bath at 65° C. under a relative humidity of 90% for 1,000 hours, whereupon the state of stain on the glass surface was visually observed, and a case where no stain observed was regarded as no stain (no problem in climate resistance).

From the evaluation results, glasses in Comparative Examples were confirmed to have a high bubble density and a low climate resistance, as compared with glasses in Examples of the present invention. Whereas, each of glasses in Examples of the present invention has a low bubble density and a high climate resistance, and accordingly it is possible to prepare a near infrared cut filter glass with few defects. Further, each glass has a low liquidus temperature and excellent production properties, whereby such a glass can suitably be used as a near infrared cut filter glass for a solid-state imaging element. Further, it has excellent near infrared absorption properties.

### INDUSTRIAL APPLICABILITY

According to the present invention, the water content in glass is low, whereby bubble defects are unlikely to occur in the step of melting glass. In addition, the climate resistance is high, whereby defects are less likely to occur also in long term use. Further, the production properties are excellent since the liquidus temperature is low, and it is extremely useful for an application to a near infrared cut filter for an imaging device since it has excellent near infrared absorption properties.

This application is a continuation of PCT Application No. PCT/JP2011/067702, filed on Aug. 2, 2011, which is based upon and claims the benefit of priority from Japanese Patent Application No. 2010-174447 filed on Aug. 3, 2010. The contents of those applications are incorporated herein by reference in its entirety.

What is claimed is:

1. A near infrared cut filter glass made of fluorophosphate glass, which comprises, as represented by cation percentage:
P⁵⁺ 25 to 55%,
Al³⁺ 1 to 25%,
R⁺ 1 to 50% (wherein R⁺ is a total content of Li^{t}, Na⁺ and K⁺),
R²+ 1 to 50% (wherein R²⁺ is a total content of Mg²⁺, Ca²⁺, Sr²⁺, Ba²⁺ and Zn²⁺),
Cu²⁺ 1 to 10% and
Sb³⁺ 0 to 3%,
and comprises as represented by anion percentage:
O²⁻ 35 to 95% and
F⁻ 5 to 65%,
and which has a β-OH value of from 0.001 to 0.1 mm⁻¹.

2. The near infrared cut filter glass according to claim 1, which has a transmittance at a wavelength of 400 nm of from 75 to 92%, a transmittance at a wavelength of 700 nm of from 5 to 10% and a transmittance at a wavelength of 1,200 nm of from 10 to 20%, when calibrated such that the wavelength at which the transmittance is 50% is 615 nm, and further has a wavelength on a long wavelength side at which the transmittance is 50%, of from 575 to 700 nm, as calculated as a thickness of 0.3 mm, in a spectral transmittance at a wavelength of from 600 to 700 nm.

3. The near infrared cut filter glass according to claim 1, which has a liquidus temperature of from 700 to 850° C.

4. The near infrared cut filter glass according to claim 1, which contains substantially no PbO or As₂O₃.

5. A process for producing a near infrared cut filter glass, which comprises adjusting the water content of glass to have a β-OH value of from 0.001 to 0.1 mm⁻¹ in a period from heating of a glass raw material to solidification of molten glass, in a process for producing fluorophosphate glass to be used as a near infrared cut filter.

6. The process for producing a near infrared cut filter glass according to claim 5, wherein the adjustment of the water content is carried out by controlling the time from heating of a glass raw material to solidification of molten glass, to be from 2 to 80 hours.

7. The process for producing a near infrared cut filter glass according to claim 5, wherein the adjustment of the water content is carried out by supplying a dry gas to the atmosphere in a period from heating of a glass raw material to solidification of molten glass so as to control the dew point to be from −100 to 50° C. in the atmosphere.

8. The process for producing a near infrared cut filter glass according to claim 5, wherein as the glass raw material, a phosphate powder raw material or orthophosphoric acid having water of crystallization is used.

9. The process for producing a near infrared cut filter glass according to claim 5, wherein the fluorophosphate glass is a fluorophosphate glass having the composition as defined in claim 1.
